(19) United States
(12) Patent Application Publication
(10) Pub. No.: US 2009/0261766 A1
(43) Pub. Date: Oct. 22, 2009

(54) METHOD FOR CONTROLLING AN ELECTRIC MOTOR FED BY A CONSTANT VOLTAGE SUPPLY SYSTEM

(76) Inventors: Volker Lurk, Offenburg (DE); Stefan Koch, Kappelrodeck (DE); Patric Kahles, Buehl (DE)

Correspondence Address: MICHAEL J. STRIKER, 103 EAST NECK ROAD, HUNTINGTON, NY, 11743, US

(21) Appl. No.: 11/573,481

(22) PCT Filed: Apr. 18, 2006
(86) PCT No.: PCT/EP06/61627

§ 371 Date: Jul. 1, 2009

(30) Foreign Application Priority Data
May 25, 2005 (DE) 102005024068.2

(51) Int. Cl. H02P 6/20

(52) U.S. Cl. 318/400.42

(57) ABSTRACT

Disclosed is a method for controlling an electric motor (10) fed by a constant voltage supply system (14, 20), especially a method for controlling a fan motor which is fed by a motor vehicle power supply system using pulse width modulation and which can be connected to the constant voltage supply system via an actuator (18) in the electric circuit of the motor. According to said method, the supply voltage (U_{M}) of the motor (10) is timed according to a predefined characteristic curve substantially independently of sudden changes in the supply voltage (U_{B}) of the constant voltage supply system.

The present invention relates to a method for controlling an electric motor fed by a direct-current voltage network, in particular a method for controlling a fan motor which is fed by a motor vehicle power supply system using pulse width modulation and which can be connected to the direct-current voltage network via an actuator in the motor electrical circuit. With methods of this type it is known to protect the actuator—which is typically designed as a semiconductor switching device—of the motor electrical circuit against overload. To this end, a circuit configuration is described, e.g., in DE 34 33 538 C, which—in order to limit the power loss in a power transistor next to the component to be protected against overload—includes a shunt in the load circuit and a further switching element which becomes conductive when impermissibly high currents flow across the power transistor and bridges the control path of the power transistor to reduce the current across its main electrodes. A circuit configuration of this type is complex and costly, however, particularly since it uses an expensive precision resistor as the current measuring shunt.

It is also known in automotive technology to limit the power consumption of directcurrent motors fed by the motor vehicle power supply system via the cycle time of the supply voltage, preferably in the inaudible frequency range above approximately 20 kHz, by limiting the terminal voltage of the motor by changing the pulse-width ratio of its supply voltage. Since the power consumption of a certain motor during normal operation is known, it is also possible to realize a timed ramp of the initial on/off ratio in order to control the start-up of the direct-current motor from a standing start until it has reached its maximum speed. To ensure motor start-up, the initial on/off ratio starts—regardless of the voltage level of the direct-current voltage network at that instant—with a preset on/off ratio, which is then increased in a ramped manner in accordance with the desired acceleration of the motor until an on/off ratio of 100% is reached and, therefore, until the maximum motor speed is reached. The motor then continues to run at this maximum speed. A motor control system of this type does not guarantee reliable start-up of the motor when mains voltage is low. In addition, when mains voltage is high, there is a risk of overload of the electrical components in the circuit, in particular an overload of the output stage in the motor electrical circuit.

The object of the present invention is to ensure reliable start-up of the motor using the simplest circuit means possible, and to optimize the run-up of the motor to its maximum speed in terms of the amount of run-up time required and the resultant power loss at different available levels of supply voltage from the direct-current voltage network.

The aforementioned object is attained according to the present invention via the characterizing features of claim 1. Initially, reliable start-up of the motor is attained and, simultaneously, overload of components, particularly the output stage in the load circuit, is prevented via the starting voltage—the level of which is essentially preset in accordance with the known motor data—at a known level of power consumption. In this operating phase, optimal acceleration of the motor is attained via the timed characteristic curve assignment—which is independent of the mains voltage level—for the increase in the on/off ratio of the pulse-width modulated supply voltage of the motor. At the same time, if the supply voltage in the direct-current voltage network is high, overload is prevented.

The acceleration phase of the motor can be improved even further and power loss reduced when, after motor start-up, the supply voltage is controlled to initially increase steeply, and to then increase less steeply, until the maximum motor speed is reached. The motor therefore quickly reaches higher speeds and, simultaneously, the overall power loss is reduced in the subsequent acceleration range of the motor as the supply voltage and, therefore, the power consumption, increases at a slower rate. The characteristic curve for the control of the supply voltage for the motor is stored in a control unit, preferably in a microcontroller, which also serves to determine the level of the mains voltage of the direct-current voltage network and deliver a corrected, pulse-width modulated control voltage for the actuator in accordance with the predefined characteristic curve for an adjusted, timed change of the supply voltage for the motor.

Further details and advantageous embodiments of the inventive method result from the description of a circuit configuration for implementing the method, and from the associated voltage and current curves.

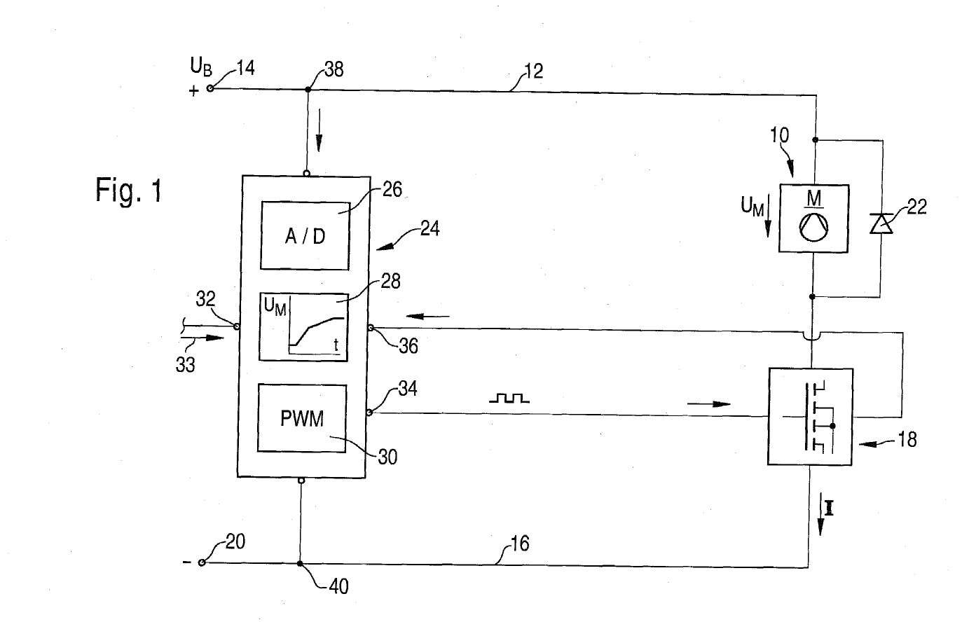

FIG. 1 shows a block diagram of a circuit configuration for the time- and mains voltage-dependent control of the supply voltage of a direct-current motor in accordance with a predefined characteristic curve,

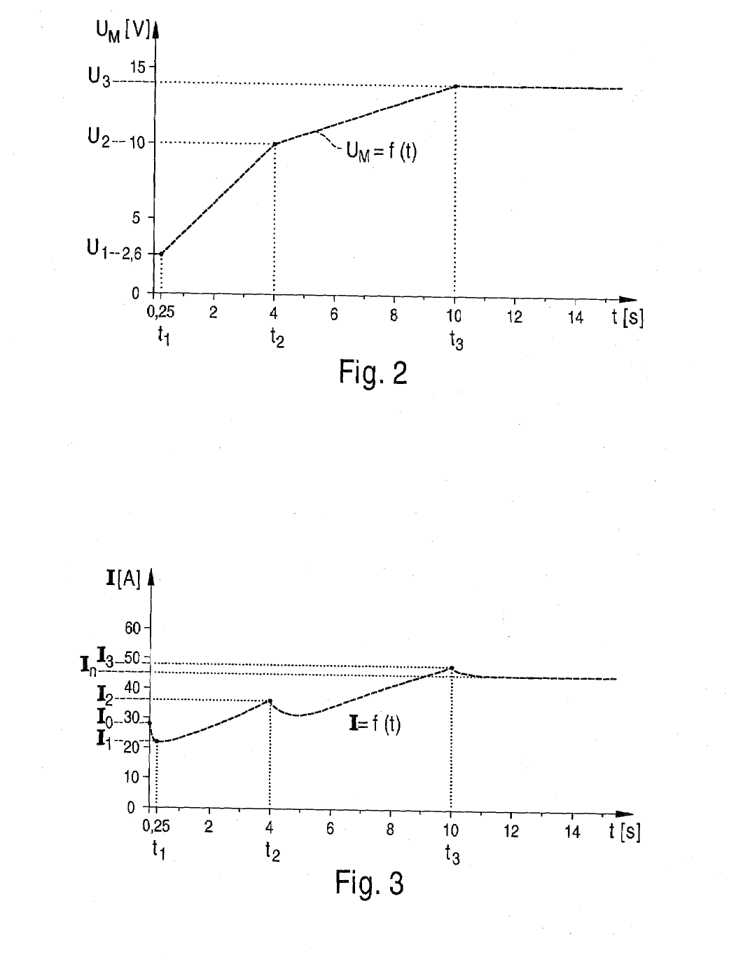

FIG. 2 shows a diagram of the timed supply voltage of the direct-current motor, and

FIG. 3 shows a diagram of the course of the motor current over time when its supply voltage is controlled as indicated in the diagram in FIG. 2.

FIG. 1 shows an electric motor 10 coupled with a fan, e.g., a fan used in motor vehicles for radiator cooling. Motor 10 is connected via a supply line 12 with positive pole 14 of a direct-current voltage network, which is the motor vehicle power supply system in this case. The second connection of electric motor 10 is connected via a supply line 16 and an actuator 18—in the form of a sense FET in this exemplary embodiment—to ground pole 20 of the direct-current voltage network. In addition, motor 10 is bridged by a free-wheeling diode 22, which carries the motor current when the current in the supply current circuit of the electric motor is interrupted in order to suppress voltage spikes. The supply voltage fed to the motor is labeled U_{M}, and the current in the motor supply circuit is labeled 1.

Electric motor 10 is controlled by a control unit 24 in the form of a microcontroller; the following components are shown in the block diagram in FIG. 1: An analog/digital converter 26, a characteristic curve memory 28, and a pulse-width modulator 30 with integrated clock-pulse generator. Control unit 24 is switched between positive pole 14 and ground pole 20 of the direct-current voltage network and simultaneously monitors the level of mains direct-current voltage U_{B}. Control unit 24 receives a start signal 33 via a control input 32 to start the motor. A control output 34 delivers the control signals for actuator 18 generated by PWM control 30. In this exemplary embodiment, actuator 18 is designed as a sense FET, which includes an additional measurement electrode, by way of which the level of motor current I is sensed and delivered to input 36 of control unit 24. A configuration of this type, which serves to monitor the motor current, in particular when the motor seizes or becomes sluggish, is described in DE 103 26 785 A and will therefore not be described in greater detail here.

The circuit configuration depicted in the block diagram in FIG. 1 for implementing the inventive method operates as follows:

A variable direct-current voltage U_{B}, as is used, e.g., in the motor vehicle power supply system, is supplied at connections 14 and 20. The voltage fluctuations of a power supply system of this type with a nominal direct-current voltage of 12 V are between operating voltage values of 9 V and 16 V, depending on the state of charge and the floating state of a battery connected thereto, and depending on other operating and ambient conditions. The objective is to compensate these voltage fluctuations to the greatest extent possible according to the present invention. To this end, mains direct-current voltage U_{B} is tapped between two connections 38 and 40 by control unit 24 and is converted in A/D converter 26 into a digital signal for further use. Start-up of motor 10 is initiated by a start signal 33 at control input 32 of the control unit. With this start signal, a preset starting voltage for the start-up of motor 10 appears at output 34 of control unit 24 for an initial short time period 0-t₁. The level of the starting voltage and the subsequent control voltages for actuator 18 are determined by the on/off ratio of PWM control 30. PWM control 30 therefore determines the ON period of actuator 18 and, therefore, the magnitude of motor current I. The shape of the characteristic curves over time will be described in greater detail with reference to FIGS. 2 and 3.

When the first, short time period 0-t₁ with direct-current voltage supply to motor 10 ends, the on/off ratio of the control voltage is increased preferably linearly, and this increase is selected depending on the level of mains direct-current voltage U_{B} that was measured such that, after a second time period t₁-t₂, a predefined level of supply voltage U_{B} for motor 10 is attained, which is still far below operating voltage U₃ of motor 10, however.

In a third time interval t₂-t₃, the on/off ratio of the control voltage for actuator 18 is also increased further in a preferably linear manner, but with a shallower slope as compared with the previous section, until operating voltage U₃ for the non-stop operation of motor 10 is reached. The level of this voltage in non-stop operation is also preferably limited via the selection of the on/off ratio of the control voltage to a fixed value, e.g., a voltage value of 14 V in a 12 V motor vehicle power supply system. If this value is not attained, due to a lower mains voltage U_{B}, an on/off ratio of 100% determines the level of the supply voltage of motor 10. If mains voltage U_{B} is adequately, high, however, it is also possible to permit a higher non-stop operation voltage of motor 10, e.g., a supply voltage U_{B} of 16 V when the aim is to attain even greater motor output.

The inventive method for the timed, voltage fluctuation-compensating control of a direct-current motor 10 in the form described above influences the level of the motor current only via the magnitude of the increase in the supply voltage. An impermissibly high current increase, which can occur, e.g., if the motor seizes or becomes sluggish, is not taken into consideration initially. This problem is generally known, however, and is solved, e.g., using the circuit configuration described in DE 103 26 785 A, with which the increase in motor current and its absolute level are monitored and can be limited as necessary, also with the aid of a sense FET that serves as actuator 18. Current limitation of this type can also be used with the subject of the application in addition to the inventive control, and the measurement accuracy that can be attained in a sense FET is at least adequate for monitoring the motor current in the overload or blocked state. In addition, in the normal operation of motor 10 described above, the change gradient of the supply voltages for the motor is predefined and is designed to attain certain voltage values U₁, U₂, U₃ at predefined points in time t₁, t₂, t₃. Instead, with the inventive method and with the aid of a sense FET used as actuator 18, it is also possible, by measuring the motor current, to adjust the change gradients of the supply voltages depending on the measurements of motor current I at certain points in time, or permanently.

FIG. 2 shows the course over time of supply voltage U_{M} supplied to electric motor 10. The motor voltage corresponds to the characteristic curve for the control voltage of actuator 18 that is stored in characteristic curve memory 28 of control unit 24. The diagram shows the characteristic curve for supplying power to a blower motor from the 12-V motor vehicle power supply system. Supply voltage U_{M} of motor 10 is held constant at a value U₁ of 2.6 V for 0.25 seconds, until time t₁. Voltage U_{M} at motor 10 then increases linearly to a value U₂ of 10 volt within 4 seconds, by time t₂, and then increases linearly but less steeply for another 10 seconds, by time t₃, and reaches specified operating voltage U₃ of 14 V. This operating voltage is then held constant.

Motor current I that flows when a supply voltage U_{M} is supplied to motor 10 as depicted in FIG. 2 is shown in FIG. 3. As illustrated, motor current I starts at a value I₀ of approx. 28 A when the motor is at a standstill, drops initially during the start phase—while supply voltage U₁ remains constant—to a value I₁ of approximately 22 A by time t₁, and then increases exponentially to a value I₂ of approximately 36 A at t₂. Subsequently, motor current I drops slightly—due to the kinetic energy stored in the motor—while supply voltage U_{M} increases at a reduced rate. It then increases until time t₃, when the operating voltage reaches a value I₃ of approximately 48 A. Once the acceleration phase has ended, motor current Iₙ that flows during non-stop operation is somewhat lower, i.e., approximately 45 A. The nominal speed of blower motors of this type for motor vehicles is approximately 3000 to 4000 rpm. It is reached after 10 seconds with a nominal system voltage of 14 V. When a supply voltage U_{M} with a bent characteristic curve as shown in FIG. 2 is supplied, the overall power loss of the motor is lower than when a supply voltage U_{M} is selected that has an unchanging slope between starting voltage U₁ and operating voltage U₃, because the losses in the range of higher motor currents and voltages are reduced considerably.

The block diagram—shown in FIG. 1—of a motor control for carrying out the inventive control method for an electric motor 10 supplied by a direct-current voltage network with fluctuating voltage U_{B} does not show the usual, additional components, such as inductance coils and capacitors for eliminating interference, nor does it depict how the circuit provides protection against mispolarization if connected incorrectly to the direct-current voltage network. To simplify the depiction, known measures for protecting motor 10 if it seizes or becomes sluggish are not depicted, nor are known assemblies of control unit 24, e.g., a resonator for generating the clock frequency for pulse-width modulator 30, or the like.

Since electric motors of the type of interest do not start up until a certain minimum voltage is applied, it is known to supply this minimum voltage to the motor immediately upon start-up. In deviation from known controls, however, with the inventive method, a minimum voltage that is required for reliable start-up of the motor is defined, independently of the mains voltage at that point in time. This minimum voltage is held constant for a predefined period of time, before at least one timed, preferably linear ramp of supply voltage U_{M}—corresponding to an on/off ratio of the control voltage that depends on the level of direct-current voltage supply U_{B} at that instant—is supplied to the motor. This supply voltage U_{M} to motor 10 can be realized using software via microcontroller control unit 24 with little effort, by changing the on/off ratio. Initially, therefore, the starting voltage is therefore provided, at a constant level, for the period of time 0-t₁ by measuring mains voltage U_{B} and by adjusting the on/off ratio of the control voltage for actuator 18 in a manner dependent thereon. To allow for seizure detection, it is permissible to include waiting periods for error detection and response during this period of time, when the starting voltage is not increased. If a blocking current occurs at a known level that does not exceed a value that is permissible for the output stage of actuator 18, this can be put up with. Due to the specified level and duration of supply voltage U₁ at start-up of motor 10, the stiction that occurs at start-up is reliably overcome. In addition, a faster motor run-up can be realized when mains voltages are low. As a result, when supply voltages U₂-U₃ of motor 10 are high, motor current I and, therefore, the end-stage load for a given run-up time becomes excessive.

By providing two different ramps of supply voltage U_{M}, the second of which has a shallower slope in the range between t₂ and t₃ than the first ramp in the range from t₁ to t₂, the motor current has relatively few fluctuations and deviations from a linear increase. In particular, a strong increase in the current curve is avoided in the range of high currents and voltages and, therefore, power loss is reduced overall.

What is claimed is:

1. A method for controlling an electric motor fed by a direct-current voltage network, particularly a method for controlling a fan motor which is fed by a motor vehicle power supply system using pulse width modulation and which can be connected to the direct-current voltage network via an actuator in the motor electrical circuit,
wherein
the supply voltage (U_{M}) of the motor (10) is timed according to a predefined characteristic curve substantially independently of sudden changes in the supply voltage (U_{B}) of the direct-current voltage network (14, 20).

2. The method as recited in claim 1,
wherein
the supply voltage (U_{M}) is held constant at a predefined value (U₁) for an initial short time period (t₁) when the motor (10) is started.

3. The method as recited in claim 1,
wherein
the supply voltage (U_{M}) is controlled in a preferably linearly increasing manner for a second time period (t₁-t₂) after the motor (10) is started until a second predefined value (U₂) is reached which is below the operating value (U₃) of the supply voltage (U_{M}) of the motor (10).

4. The method as recited in claim 1, wherein,
after the second predefined value (U₂) is reached, the supply voltage (U_{M}) of the motor (10) is increased further, with a preferably linear increase that is reduced compared with the previous time period (t₂-t₃), until the operating voltage value (U₃) of the motor (10) is reached, and it is then held constant.

5. The method as recited in claim 1,
wherein
the characteristic curve for the supply voltage (U_{M}) of the motor (10) is stored in a control unit (24) which monitors the level of the mains voltage (U_{B}) of the direct-current voltage network (14, 20) and, in accordance with the characteristic curve (U_{M}=f(t)), delivers a corrected, pulse width-modulated control voltage (34) for the actuator (18) in the motor electrical circuit.

6. The method as recited in claim 1,
wherein
a sense FET is used as the actuator (18) in the motor electrical circuit.

7. The method as recited in claim 1,
wherein
the slope and duration (t₁-t₂-t₃) of the characteristic curve sections of the supply voltage (U_{M}) are dimensioned such that a specifiable operating voltage and/or operating speed of the motor (10) are attained within a specifiable time period (t3).

8. The method as recited in claim 1,
wherein
the on/off ratio of the pulse-width modulation (PWM) of the supply voltage (U_{M}) of the motor (10) is controlled using software.

9. The method as recited in claim 1,
wherein
the change gradients of the supply voltage (U_{M}) of the motor (10) are oriented to fixed maximum values (U₂, t₂; U₃, t₃), independently of the particular level of the mains voltage (U_{B}).

10. The method as recited in claim 1,
wherein
the level of the motor current (I) is measured as predefinable points in time, and the change gradients of the supply voltages (U_{M}) of the motor (10) are adjusted based on the measured value of the current (I).
